(19) United States
(12) Patent Application Publication
(10) Pub. No.: US 2025/0204521 A1
(43) Pub. Date: Jun. 26, 2025

(54) FORMULATIONS WITH REDUCED LEVELS OF VOLATILE ORGANIC COMPOUNDS

(71) Applicant: S. C. Johnson & Son, Inc., Racine, WI (US)

(72) Inventors: Abdul Siddiqui, Racine, WI (US); Tapash Deb, Racine, WI (US); Steven A. Zach, Racine, WI (US)

(21) Appl. No.: 18/395,221

(22) Filed: Dec. 22, 2023

(51) Int. Cl. A01N 25/06; A01N 53/00; A01P 7/04; B65D 83/14

(52) U.S. Cl. CPC A01N 25/06; A01N 53/00; A01P 7/04; B65D 83/141

(57) ABSTRACT

The present disclosure provides a pesticidal composition that includes an active phase with one or more solvents and an active, an aqueous phase including water, and a propellant. Further, the one or more solvents are selected from the group consisting of citric acid esters, cyclohexanone, ethanol, acetone, glycol ethers, C14-16 saturated alkanes, and C11-C16 aliphatic hydrocarbons. Furthermore, the composition has a volatile organic compound (VOC) content of less than 8 wt. %, based on a total weight of the composition.

### CROSS-REFERENCE TO RELATED APPLICATIONS

Not applicable.

### STATEMENT REGARDING FEDERALLY SPONSORED RESEARCH

Not applicable.

### BACKGROUND

### 1. Technology Field

The present disclosure relates to a pest control composition, and more particularly, to a pesticidal (or pest control) formulation with reduced levels of Volatile Organic Compounds (VOCs) for disabling by knocking down and killing insects including cypermethrin, deltamethrin, imiprothrin, and mixtures thereof. The present disclosure also relates to a pest control composition including (i) an active phase, which may contain a hydrocarbon solvent, actives, a fragrance, and an emulsifier, (ii) an aqueous phase, which may contain water with a corrosion inhibitor, and (iii) a propellant (e.g., a liquified petroleum gas (LPG) propellant).

### 2. Description of the Background

Liquid components or compositions, such as fragrance oils, insecticides, medicines, cleaners, polishes, hair sprays, cosmetics, paints, and the like are composed of materials that are mostly insoluble in water. These liquid components and compositions are used in the manufacture of aerosol compositions. Such liquid components and compositions usually require the inclusion of solvents to produce a homogeneous emulsion blend in water. Many of the typically employed solvents are VOCs.

Further, aerosol compositions are generally pressurized with hydrocarbon propellants. Hydrocarbon propellants, such as A-17 to A-107, NIP-31 to NIP-107, or NP propellant LPG blends, contain VOCs. Sometimes fewer VOCs may be desirable for environmental reasons. Thus, there is a need for aerosol systems with reduced levels of VOCs without compromising product performance. However, a reduction in the hydrocarbon propellant content in a formulation can adversely affect the product performance. Specifically, reducing the propellant content in the aerosol formulation may result in excessive product remaining in the container at the end of the life of the dispenser assembly (product retention), a disruption of the spray pattern, and an increase in the size of particles of the dispensed product (increased particle size). This can also impact consumer perception regarding the quality and efficacy of the product. Therefore, a need exists for an optimized pest control formulation with low levels of VOCs that retains product performance as compared to pest control formulations with higher VOCs.

### SUMMARY

In one aspect, a pesticidal composition is provided. In this embodiment, the composition includes an active phase with one or more solvents and an active, an aqueous phase including water, a corrosion inhibitor, and a propellant. Further, the one or more solvents are selected from the group consisting of citric acid esters, cyclohexanone, glycol ethers, ethanol, acetone, C14-16 saturated alkanes, and C11-C16 aliphatic hydrocarbons. Additionally, the composition has a volatile organic compound content of less than 8 wt. %, based on a total weight of the composition.

In further embodiments, the active is at least one of cypermethrin, imiprothrin, and combinations thereof, the one or more solvents include glycol ethers and C14-C16 saturated alkanes, and the propellant is less than about 8 wt. %, based on a total weight of the composition. In other embodiments, the active is at least one of cypermethrin, imiprothrin, and combinations thereof, the one or more solvents include citric acid esters and C14-C16 saturated alkanes, and the propellant is less than about 8 wt. %, based on a total weight of the composition. In another embodiment, the composition further includes a sorbitan monooleate emulsifier between about 0.01 wt. % and 2 wt. %, based on a total weight of the composition. Additionally, in some embodiments, the composition further includes an ammonium benzoate corrosion inhibitor between about 0.05 wt. % and 2 wt. %, based on a total weight of the composition.

In other embodiments, the one or more solvents are above 25 wt. %, based on a total weight of the composition. Here, the one or more solvents may be selected from the group consisting of citric acid esters, glycol ethers, and combinations thereof.

According to another aspect of the present disclosure, another pesticidal composition is provided. Here, the composition includes an active phase including one or more solvents and an active, an aqueous phase including water, and a propellant. Further, the one or more solvents are above 25 wt. %, based on a total weight of the composition, and the composition has a volatile organic compound content of less than 8 wt. %, based on the total weight of the composition.

In further embodiments, the active is at least one of cypermethrin, deltamethrin, and combinations thereof, the one or more solvents includes C11-C16 aliphatic hydrocarbons, and the propellant is less than 8 wt. %, based on the total weight of the composition. In other embodiments, the active is at least one of cypermethrin, deltamethrin, and combinations thereof, the one or more solvents includes C14-C16 saturated alkanes, and the propellant is less than 8 wt. %, based on the total weight of the composition. In some embodiments, the active is at least one of cypermethrin, deltamethrin, and combinations thereof, the one or more solvents includes glycol ethers and C14-C16 saturated alkanes, and the propellant is less than 8 wt. %, based on the total weight of the composition.

In other embodiments, the one or more solvents are selected from the group consisting of citric acid esters, cyclohexanone, C14-16 saturated alkanes, and C11-C16 aliphatic hydrocarbons, glycol ethers, and chloroform. In further embodiments, the one or more solvents are selected from the group consisting of citric acid esters, glycol ethers, and combinations thereof.

According to yet another aspect of the present disclosure, another pesticidal composition is provided. In this embodiment, the composition includes an active phase with one or more solvents and an active, an aqueous phase including water, and a propellant. In this embodiment, the propellant includes isobutane and propane, and the isobutane to propane weight ratio is between about 20:80 to about 45:55. Further, the composition has a volatile organic compound content of less than 8 wt. %, based on a total weight of the composition.

In further embodiments, the isobutane to propane weight ratio is about 30:70. Additionally, in some embodiments, the active is at least one of cypermethrin, imiprothrin, and combinations thereof, the one or more solvents includes glycol ethers and C14-C16 saturated alkanes, and the propellant is less than 10 wt. %, based on the total weight of the composition. In other embodiments, the active is at least one of cypermethrin, imiprothrin, and combinations thereof, the one or more solvents includes citric acid esters and C14-C16 saturated alkanes, and the propellant is less than about 10 wt. %, based on the total weight of the composition. Further, in some embodiments, the composition includes a sorbitan monooleate emulsifier between about 0.01 wt. % and 2 wt. %, based on a total weight of the composition, and an ammonium benzoate corrosion inhibitor between about 0.05 wt. % and 2 wt. %, based on the total weight of the composition. Even further, in some embodiments, the one or more solvents are above 30 wt. %, based on a total weight of the composition.

According to another aspect of the present disclosure, an aerosol dispenser system is provided. Here, the aerosol dispenser system may include an enclosed container accommodating a fluid composition under pressure, a valve assembly coupled to and in fluid communication with the container, an actuator body coupled to and in fluid communication with the valve assembly, and at least one swirl nozzle insert coupled to and in fluid communication with the actuator body. Further, in this embodiment, the liquid is a composition that includes a solvent, an active, and a propellant, and the solvent is selected from the group consisting of citric acid esters, cyclohexanone, glycol ethers, C14-C16 saturated alkanes, and C11-C16 aliphatic hydrocarbons. Additionally, the aerosol dispenser system has a volatile organic compound (VOC) content of less than 8 wt. %, based on a total weight of the composition.

In further embodiments, the active is at least one of cypermethrin, imiprothrin, and combinations thereof, the solvent includes glycol ethers and C14-C16 saturated alkanes, and the propellant is less than 10 wt. %, based on a total weight of the composition. In other embodiments, the active is at least one of cypermethrin, imiprothrin, and combinations thereof, the solvent includes citric acid esters and C14-C16 saturated alkanes, and the propellant is less than about 10 wt. %. In additional embodiments of this aspect, the composition further includes a sorbitan monooleate emulsifier, the amount of which is between about 0.01 wt. % and 2 wt. %, based on a total weight of the composition, and an ammonium benzoate corrosion inhibitor, the amount of which is between about 0.05 wt. % and 0.2 wt. %, based on a total weight of the composition.

According to yet another embodiment of the present disclosure, a dispensing system is provided that includes a container, a composition disposed in the container, and an overcap assembly attached to the container. Here, the overcap assembly includes a body, an actuator, and a nozzle having an exit orifice with a diameter of between about 0.75 mm and about 2 mm. Further, the composition includes an active phase with one or more solvents and an active, an aqueous phase including water, and a propellant. Additionally, the one or more solvent are selected from the group consisting of citric acid esters, glycol ethers, C14-16 saturated alkanes, and C11-C16 aliphatic hydrocarbons. Even further, the composition has a volatile organic compound of less than 8 wt. %, based on a total weight of the composition.

In further embodiments, the exit orifice has a diameter of between about 1.0 mm and about 1.3 mm. In other embodiments, the composition is dispensed at a Dv(50) particle size of between about 130 μm and about 210 μm when the container is 100% full. Further, in some embodiments, the composition is dispensed at a discharge rate of between about 2.2 g/s and about 3.4 g/s, and the system produces a spray distance between about 15 inches and about 20 inches.

### BRIEF DESCRIPTION OF THE DRAWINGS

Non-limiting embodiments of the present invention will be described by way of example with reference to the accompanying figures, which are schematic and are not intended to be drawn to scale. In the figures, each identical or nearly identical component illustrated is typically represented by a single numeral. For purposes of clarity, not every component is labeled in every figure, nor is every component of each embodiment of the present disclosure shown where illustration is not necessary to allow those of ordinary skill in the art to understand the disclosure.

FIG. 1 is a front isometric view of a dispensing system that includes a container and an overcap attached thereto;

FIG. 2 is a front isometric view of the container of FIG. 1; and

FIG. 3 is a cross-sectional side view of the product dispensing system of FIG. 1 taken generally along the line 3-3 shown in FIG. 1;

FIG. 4 is a front isometric view of another overcap assembly that may be used with the formulations of the present disclosure;

FIG. 5 is a front view of the overcap assembly of FIG. 4;

FIG. 6 is a cross-sectional view of the overcap assembly of FIG. 4, taken along the line 6-6 shown in FIG. 5;

FIG. 7 is a partial, enlarged cross-sectional view of the overcap assembly of FIG. 4;

FIG. 8 is a front isometric view of yet another overcap assembly that may be used with the formulations of the present disclosure;

FIG. 9 is a top view of the overcap assembly of FIG. 8;

FIG. 10 is a cross-sectional view of the overcap assembly of FIG. 8, taken along the line 10-10 shown in FIG. 9;

FIG. 11 is a partial, enlarged cross-sectional view of the overcap assembly of FIG. 8;

FIG. 12 is a front isometric view of a spray insert that may be used with the formulations of the present disclosure;

FIG. 13 is a side elevational view of the spray insert of FIG. 12;

FIG. 14 is a cross-sectional view of the spray insert of FIG. 12, taken along line 14-14 of FIG. 13;

FIG. 15 is a partial, enlarged cross-sectional view of the spray insert of FIG. 12; and

FIG. 16 illustrates several spray patterns of the overcap assemblies and spray insert of the present disclosure used in conjunction with the formulations of the present disclosure.

### DETAILED DESCRIPTION OF THE DRAWINGS

The term “about” or “approximately” means within an acceptable error range for the particular value as determined by one of ordinary skill in the art, which will depend in part on how the value is measured or determined, i.e., the limitations of the measurement system, i.e., the degree of precision required for a particular purpose, such as a pharmaceutical formulation. The term “about” refers to variation in the numerical quantity that may occur, for example, through typical measuring and liquid handling procedures used for making concentrates or solutions in the real world; through inadvertent error in these procedures; through differences in the manufacture, source, or purity of the ingredients used to make the compositions or carry out the methods; and the like. The term “about” may also encompass amounts that differ due to different equilibrium conditions for a composition resulting from a particular initial mixture.

In one embodiment, the term “about” refers to a range of values+/−5% of a specified value. For example, “about” can mean within 1 or more than 1 standard deviations, per the practice in the art. Alternatively, “about” can mean a range of up to 20%, preferably up to 10%, more preferably up to 5%, and more preferably still up to 1% of a given value. Alternatively, particularly with respect to biological systems or processes, the term can mean within an order of magnitude, preferably within 5-fold, and more preferably within 2-fold, of a value. Where particular values are described in the application and claims, unless otherwise stated the term “about” meaning within an acceptable error range for the particular value should be assumed.

The term “substantially,” as used herein, may mean at least about 80%, preferably at least about 90%, more preferably at least about 99%, for example at least about 99.9%. In some embodiments, the term “substantially” can mean completely, or about 100%.

The term “weight percent”, “wt. %”, “wt. %,” “percent by weight”, “% by weight”, and variations thereof, as used herein, refer to the concentration of a substance as the weight of that substance divided by the total weight of the composition and multiplied by 100. It is understood that, as used here, “percent”, “%”, and the like may be synonymous with “weight percent”, “wt. %”, etc.

As used herein, “pests” can mean any organism whose existence it can be desirable to control. Pests can include, for example, bacteria, cestodes, fungi, insects, nematodes, parasites, plants, and the like. In addition, as used herein, “pesticidal” can mean, for example, antibacterial, antifungal, antiparasitic, herbicidal, insecticidal, and the like.

More so, for purposes of simplicity, the term “insect” is used in this application. However, it should be understood that the term “insect” refers, not only to insects, but may also refer to mites, spiders, and other arachnids, larvae, and like invertebrates. As used herein, the term “insect” refers to and includes but is not limited to insects or arachnids capable of acting as vectors for disease to humans, animals, birds, fish, plants or plant parts, or capable of irritating or causing economic damage thereto. Examples include but are not limited to nematodes, biting insects (such as mosquitoes, gnats, horse flies, ticks, tsetse flies, blowfly, screw fly, bed bugs, fleas, lice and sea lice), sap-sucking insects (such as aphids and thrips) and further include arachnids, ticks, termites, silverfish, ants, cockroaches, locust, fruit flies, wasps, hornets, yellow jackets, scorpions, chiggers and mites (such as dust mites).

Embodiments of the invention can be used to control parasites. The term “parasite” encompasses numerous protozoa, helminths, and ectoparasites. Protozoa may include the ameba, flagellates, ciliates, and the sporozoa. Protozoa typically infect the blood and tissue and may be transmitted through the bite of a mosquito. Protozoa are responsible for such diseases as malaria, trypanosomiasis, leishmaniasis, toxoplasmosis, and cryptosporidiosis. Helminths are typically classified into three groups, flatworms, roundworms, and thorny-headed worms. Helminths are responsible for such diseases as enterobiasis, ascariasis, taeniasis, cysticercosis, and schistosomiasis. Ectoparasites may include mosquitoes, ticks, fleas, lice, and mites. Many ectoparasites may cause disease on their own, but are even more important as vectors of a number of different pathogens, including protozoa.

Further, for purposes of this application, the term “pest control” shall refer to having a repellent effect, a pesticidal effect, or both. “Repellent effect” is an effect wherein more insects are repelled away from a host or area that has been treated with the composition than a control host or area that has not been treated with the composition. Similarly, the term “repellency” or “repelling” or “repel” refers to the ability of the compositions described herein to cause a pest or insect to deviate away from or avoid a surface, object or insect breeding site treated with said composition. In some embodiments, a repellent effect is an effect wherein at least about 75% of insects are repelled away from a host or area that has been treated with the composition. In some embodiments, however, a repellent effect is an effect wherein at least about 90% of insects are repelled away from a host or area that has been treated with the composition. In addition, “pesticidal effect” or “insecticidal effect” is an effect wherein treatment with a composition causes at least about 1% of the insects to die. In this regard, an LC1 to LC100 (lethal concentration) or an LDI to LD100 (lethal dose) of a composition will cause a pesticidal effect. In some embodiments, the pesticidal effect or the insecticidal effect is an effect wherein treatment with a composition causes at least about 5% of the exposed insects to die. In some embodiments, the target pest is a non-insect, such as a parasite.

As used herein, the term “killing” or “kill” refers to the ability of at least one active in a pesticidal composition to render an insect dead. As further used herein, the term “knocking down” or “knockdown” refers to the ability of the composition described herein to render an insect immobile for a pre-determined period of time. For example, a flying insect contacted with a composition described herein is said to be “knocked down” if it falls to ground and is unable to fly, even though it may be able to move body parts so it cannot be categorized as completely paralyzed. The insect's ability to move, feed, reproduce, spread disease, or irritate is severely curtailed during the period in which it is knocked down. As an additional example, a crawling insect contacted with the composition described herein is said to be “knocked down” if it flips over onto its back and/or it is unable to crawl, even though involuntary twitches or spasms may remain. The insect's ability to move, feed, reproduce, spread disease, or irritate is severely curtailed during the period in which it is knocked down.

It is known in the pest control field that consumers desire a product that has a reduced environmental impact. Therefore, it is important to develop a pest control composition that has sustainable components and does not compromise the insect killing or knock-down efficacies. It has been found that a low-VOC pest control composition according to an embodiment of the present disclosure comprising at least one insecticide active agent, a solvent, a carrier, a propellant, an emulsifier, and a corrosion inhibitor provides such benefits.

The compositions described herein present novel combinations of active agents and/or other components that result in an improved pest control composition offering consumers a sustainable, low-environmental impact composition without sacrificing efficacy. The sustainable composition allows the user to spray the pests and have confidence the composition has a low impact on the environment and indoor air quality when compared to some other pest control products with higher VOC content.

In an embodiment, one active ingredient is fast acting and provides “knock down” of the insects so they cannot move after exposure. Another active ingredient ultimately kills the insect, ensuring death after the insects are “knocked down.”

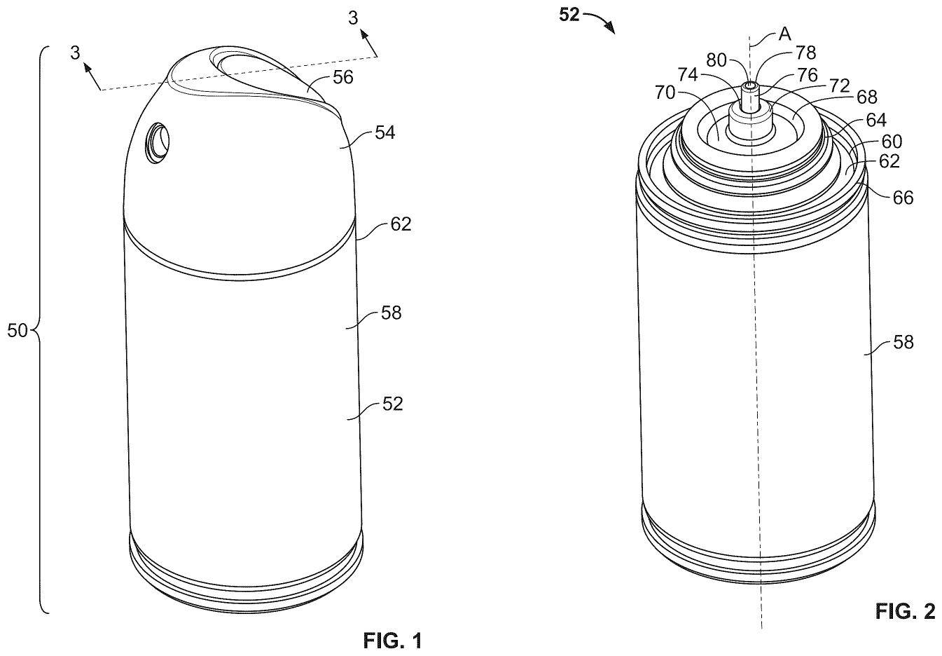

FIG. 1 depicts a dispensing system 50 that includes a container 52 and an overcap 54 disposed thereon. An actuator 56 is at least partially disposed within the overcap 54 and facilitates the composition of the present disclosure from being dispensed from the dispensing system 50. In use, the product dispensing system 50 is adapted to release the composition from the container 52 upon the occurrence of a particular condition, such as the manual activation of the overcap 54 by a user of the dispensing system 50.

As best seen in FIG. 2, the container 52 comprises a substantially cylindrical body 58 with an opening 60 at a top end 62 thereof. A mounting cup 64 is crimped to a tapered portion of the container 52, which defines the opening 60. The mounting cup 64 seals the top end 62 of the body 58. A second crimped portion at a bottom end of the tapered portion defines a seam 66. The seam 66 and/or mounting cup 64 provide a location in which the overcap 54 may be attached thereto, as is known in the art.

Still referring to FIG. 2, the mounting cup 64 is generally circular-shaped and may include an annular wall 68 that protrudes upwardly from a base 70 of the mounting cup 64 adjacent the area of crimping. A central pedestal 72 extends upwardly from a central portion 74 of the base 70. A conventional valve assembly may include a valve stem 76, which is connected to a valve body (not shown) and a valve spring (not shown) disposed within the container 52. The valve stem 76 extends upwardly through the pedestal 72, wherein a distal end 78 extends upwardly away from the pedestal 72 and is adapted to interact with the actuator 56 disposed within the overcap 54. A longitudinal axis A extends through the valve stem 76.

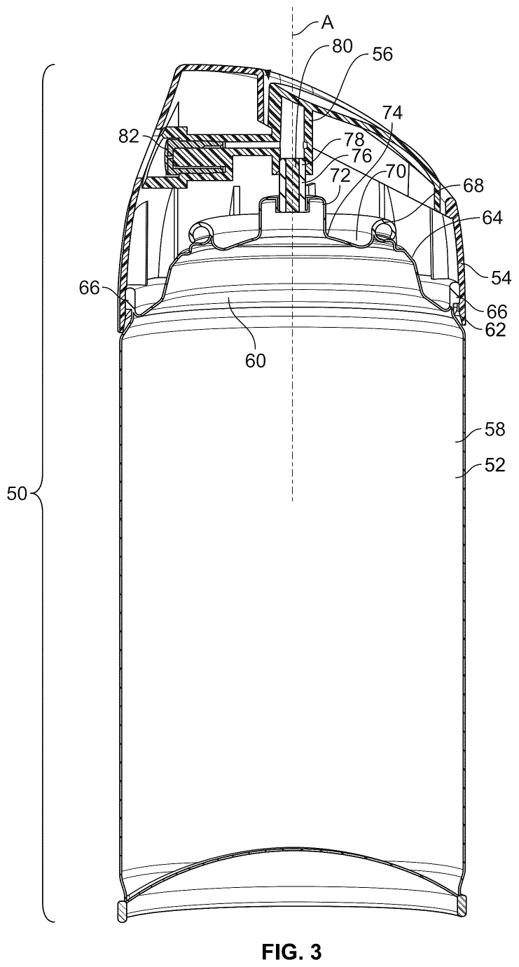

As best seen in FIG. 3, prior to use, the actuator 56 is placed in fluid communication with the distal end 78 of the valve stem 76. A user may manually or automatically operate the actuator 56 to open the valve assembly, which causes a pressure differential between the container interior and the atmosphere to force the contents of the container 52 through the valve stem 76, through an orifice 80, out of a swirl chamber 82, and into the atmosphere. While the present disclosure describes the composition with respect to the aerosol container 52, the compositions of the present disclosure may be practiced with many types of containers known to those skilled in the art.

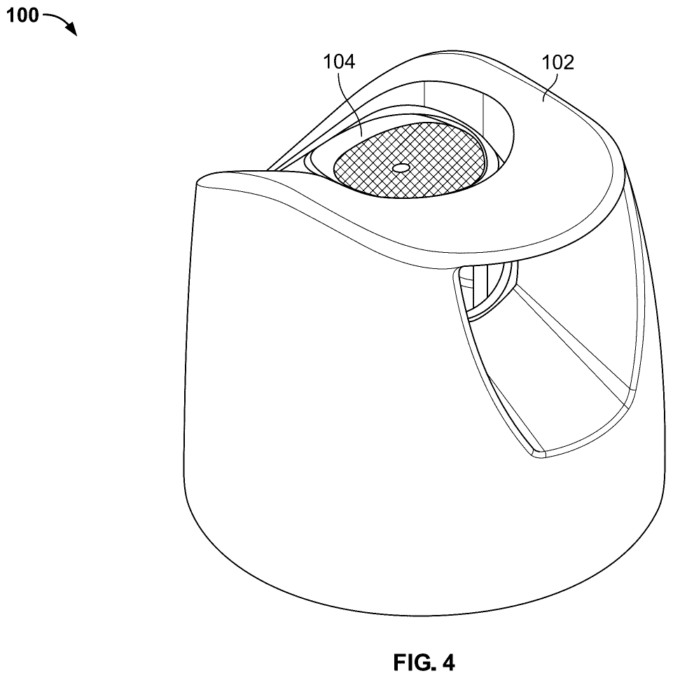

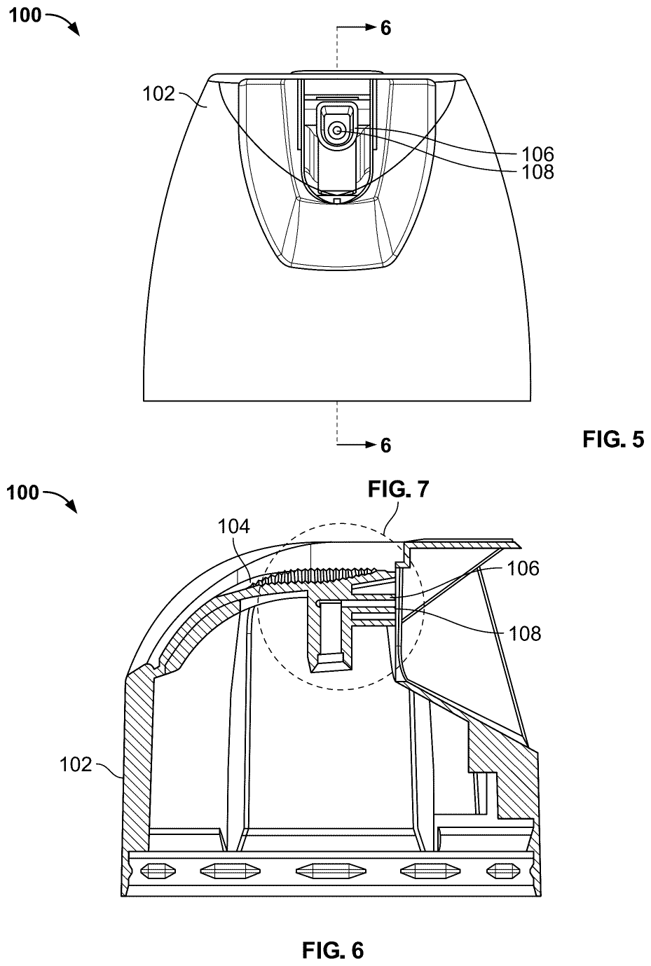

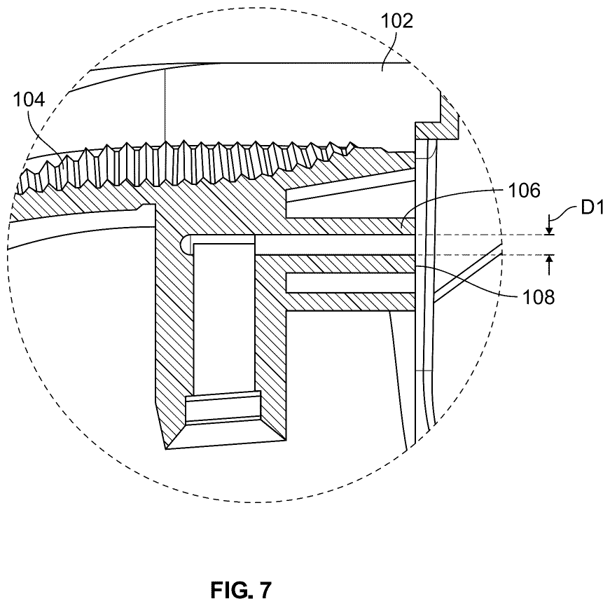

FIGS. 4-7 depict another overcap assembly 100 that may be used in conjunction with the dispensing system 50 and the formulations herein. In particular, FIG. 4 is a front isometric view of the overcap assembly 100, FIG. 5 is a front view of the overcap assembly 100, FIG. 6 is a cross-section view of the overcap assembly 100, taken along the line 6-6 of FIG. 5, and FIG. 7 is a partial, enlarged cross-sectional view of the overcap 100.

In this embodiment, the overcap assembly 100 includes a body 102, an actuator or actuator button 104, and a nozzle 106. The nozzle 106 may extend outwardly from the actuator button 104, and the actuator button 104 may be at least partially disposed within the body 102 and may facilitate the formulation or product being dispensed from a container or dispensing system, such as the dispensing system 50. In use, the overcap assembly 100 may be adapted to release a product from a container upon the occurrence of a particular condition, such as the manual depression of the actuator button 104 by a user of the dispensing system 50.

The formulation or product dispensed, which will be further discussed and disclosed herein, may be discharged through an exit aperture or orifice 108 of the nozzle 106. Additionally, as shown in FIGS. 6 and 7, the exit aperture or orifice 108 may have a diameter D1. As will be further discussed, a change in the performance of several formulations was observed as the orifice diameter was optimized and decreased. In short, a range in exit orifice diameter (such as D1 of the exit aperture or orifice 108) in combination with the formulations of the present disclosure provided a synergistic effect in performance, thereby providing a lower VOC formulation that performed at least at parity with a higher VOC formulation.

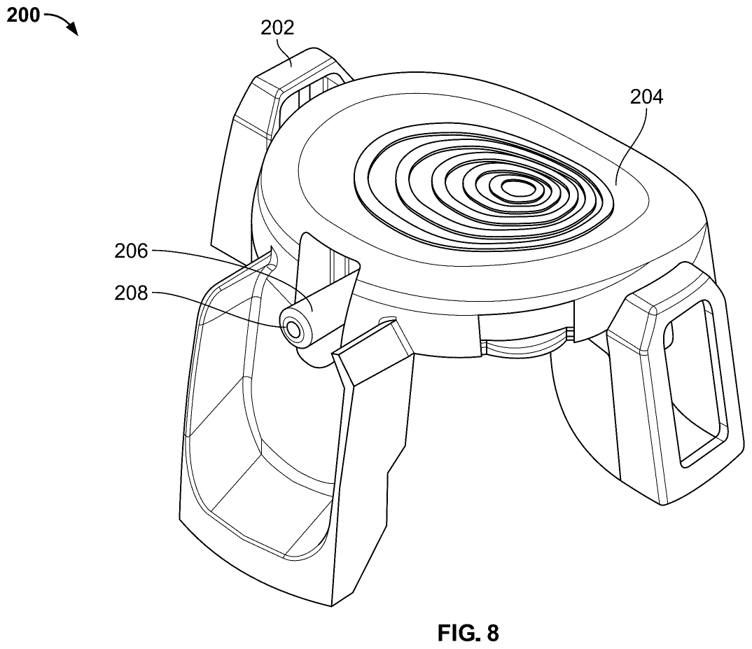

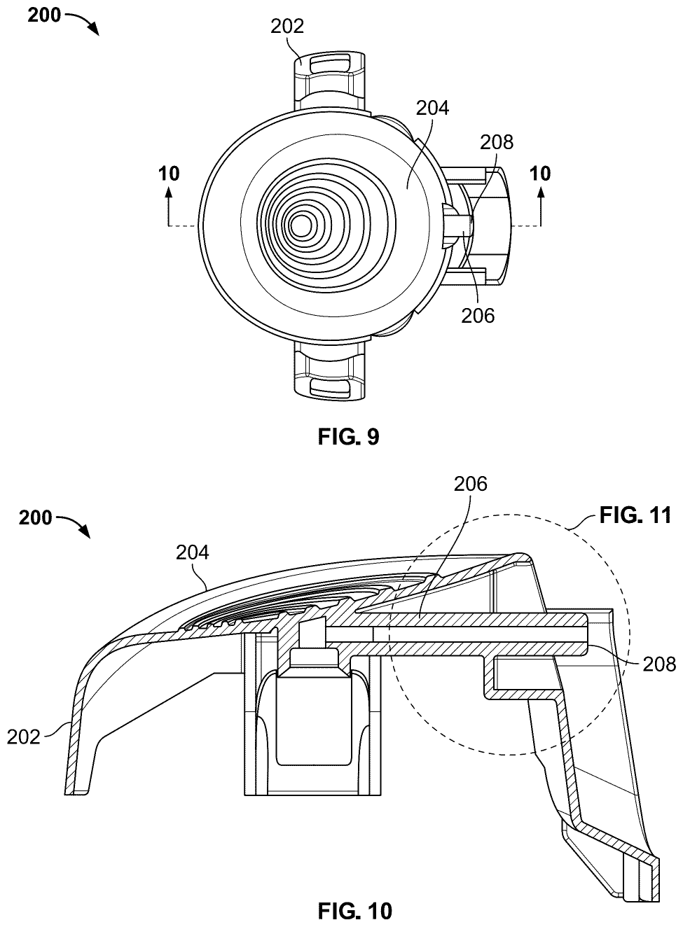

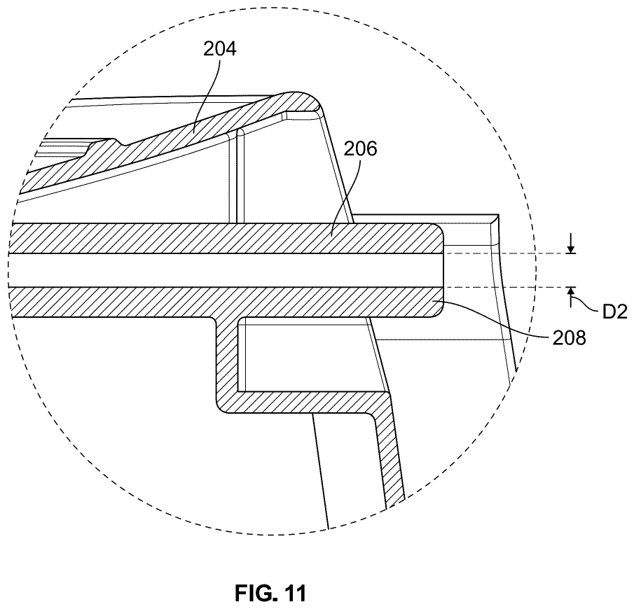

FIGS. 8-11 depict yet another overcap assembly 200 that may be used in conjunction with the dispensing system 50 and the formulations herein. Here, FIG. 8 is a front isometric view of the overcap assembly 200, FIG. 9 is a top view thereof, FIG. 10 is a cross-sectional view of the overcap assembly 200, taken along the line 10-10 shown in FIG. 9, and FIG. 11 is a partial, enlarged cross-sectional view of the overcap assembly 200.

In this embodiment, the overcap assembly 200 includes a body 202, an actuator or actuator button 204, and a nozzle 206. The nozzle 206 may extend outwardly from the actuator button 104, and the actuator button 204 may be at least partially disposed within the body 202 and may facilitate the formulation or product being dispensed from a container or dispensing system, such as the dispensing system 50. In use, the overcap assembly 200 may be adapted to release a product from a container upon the occurrence of a particular condition, such as the manual depression of the actuator button 204 by a user of the dispensing system 50.

The formulation or product dispensed, which will be further discussed and disclosed herein, may be discharged through an exit aperture or orifice 208 of the nozzle 206. Additionally, as shown in FIGS. 10 and 11, the first exit aperture or orifice 208 may have a diameter D2 (see FIG. 11). As previously discussed herein, a change in the performance between several formulations was observed as the orifice diameter decreased. In short, a range in exit orifice diameter (such as D2 of the exit aperture or orifice 208) in combination the formulations of the present disclosure provided a synergistic effect in performance, thereby providing a lower VOC formulation that performed at least at parity with the higher VOC formulation.

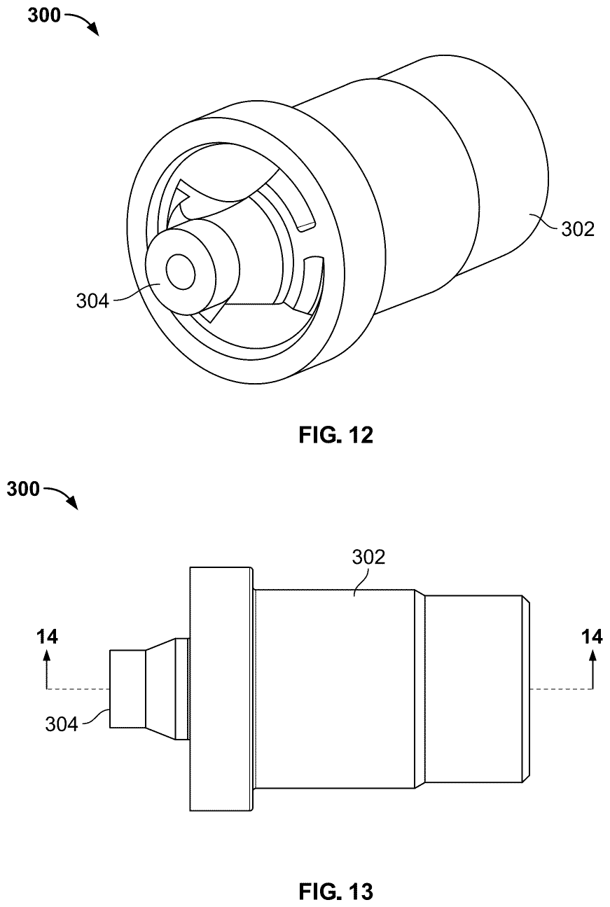

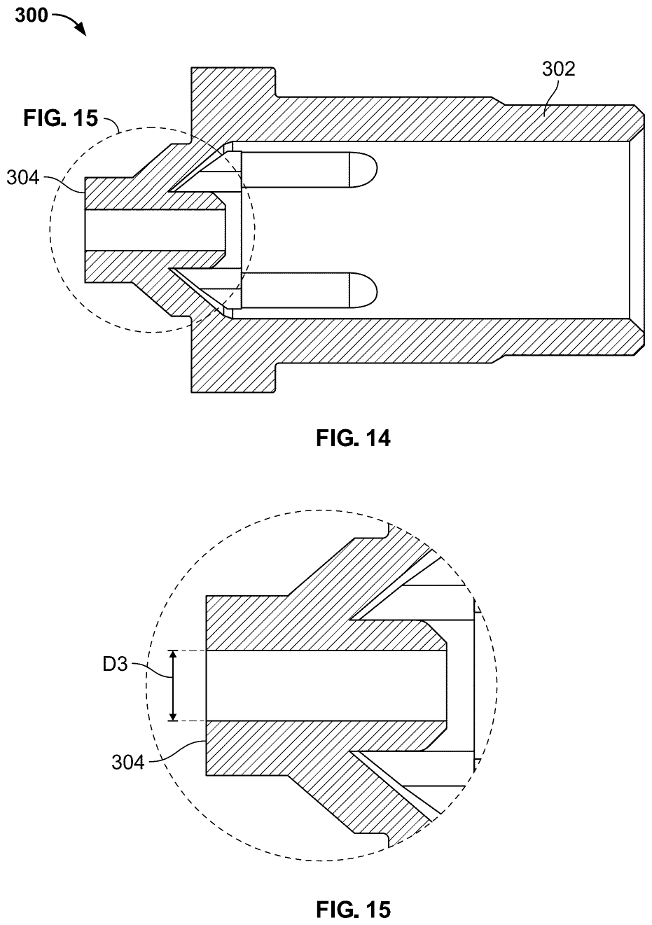

FIGS. 12-15 depict a spray insert 300 that may be used in conjunction with the dispensing system 50, the overcap assembly 100, the overcap assembly 200, and/or the formulations herein. More particularly, the spray insert 300 may be positioned or inserted near an aperture or exit orifice of the overcap assemblies, such as the exit aperture or orifices 108, 208. FIG. 12 is a front isometric view of the spray insert 300, FIG. 13 is a side elevational view of the spray insert 300, FIG. 14 is a cross-sectional view of the spray insert 300, taken along line 14-14 of FIG. 13, and FIG. 15 is a partial, enlarged cross-sectional view of the spray insert 300.

The spray insert 300 may have a body 302 and a discharge outlet 304, which may be defined by a diameter D3. Here, like the diameters D1, D2, the diameter D3 may be optimized in conjunction with the formulations of the present disclosure. More particularly, as previously discussed herein, a change in the performance between several formulations was observed as the orifice diameter decreased. In short, a range in exit orifice diameter (such as D3 of the discharge outlet 304) in combination the formulations of the present disclosure provided a synergistic effect in performance, thereby providing a lower VOC formulation that performed at least at parity with the higher VOC formulation.

For example, in some embodiments, the exit aperture or orifices 108, 208 or discharge outlet may have diameters D1, D2, D3 that are between about 0.75 millimeters (mm) and about 2.50 mm, or between about 0.75 mm and about 2.00 mm, or between about 0.75 mm and about 1.25 mm, or between about 0.75 mm and about 1.0 mm. In some embodiments, the diameters D1, D2, D3 are about 1.00 mm. In other embodiments, the diameters D1, D2, D3 are between about 1.50 mm and about 2.50 mm, or between about 1.75 mm and about 2.30 mm, or about 2.00 mm, or about 1.30 mm.

It was discovered that optimizing and decreasing the exit orifice diameter produced a number of benefits. The reduction in diameter prevented flash vaporization of the propellant before exiting the nozzle, which allowed for the dissolved propellant to burst outside of the nozzle. This, in turn, produced a focused spray with even distribution, optimal particle sizes, and optimal spray patterns at about 12 to 18 inches away from the nozzle. The focused spray enables targeting of an individual bug (as opposed to coating an unintentionally large area) with a pesticide which will not drip after being sprayed on baseboards, corners, or crevasses.

Next, as will be discussed herein, the compositions or formulations of the present disclosure provide a pest control or insecticidal composition with reduced levels of VOC (e.g., less than 8 wt. % VOC). Further, to achieve these low levels of VOCs, the compositions employ a combination of effective non-VOC solvents, optimal propellant formulations and concentrations, and beneficial amounts of emulsifiers. Each of these aspects, along with the other components of the compositions, will now be discussed in detail.

Active agent. The active agent imparts insecticidal and/or insect repellent properties to the low-VOC pest composition. In some embodiments, the active agent of the pest control compositions of the present disclosure can include one or more pyrethrins, pyrethroids, and combinations thereof. In specific embodiments, the active agent or agents of the low-VOC pest control composition includes one or more of imiprothrin, cypermethrin, deltamethrin, and combinations thereof. In some embodiments, the active of the low-VOC pest control composition includes cypermethrin. In other embodiments, the active of the low-VOC pest control composition includes imiprothrin. In other embodiments, the active of the low-VOC pest control composition includes deltamethrin. In other embodiments, the active of the low-VOC pest control composition includes cypermethrin and imiprothrin. In other embodiments, the active of the low-VOC pest control composition includes imiprothrin and deltamethrin.

The one or more active agents may be included in a range between about 0.01 wt. % and about 5 wt. %, or between about 0.01 wt. % and about 3 wt. %, or between about 0.01 wt. % and about 2 wt. %, or between about 0.01 wt. % and about 1 wt. %, or between about 0.01 wt. % and about 0.5 wt. %, or between about 0.01 wt. % and about 0.3 wt. %, or between about 0.01 wt. % and about 0.25 wt. %, or between about 0.01 wt. % and about 0.2 wt. %. Further, in particular embodiments, the one or more active agents may be included in a concentration of about 0.22 wt. %.

Cypermethrin (CAS No. 52315-07-8) is a synthetic pyrethroid that behaves as a fast-acting neurotoxin in insects. Cypermethrin has the IUPAC name [cyano-(3-phenoxyphenyl)methyl]3-(2,2-dichloroethenyl)-2,2-dimethylcyclopropane-1-carboxylate. Cypermethrin can be included in the composition in at least 0.005 wt. % or at least 0.01 wt. % and up to about 0.02 wt. %, up to about 0.03 wt. %, up to about 0.04 wt. %, up to about 0.05 wt. %, up to about 0.06 wt. %, up to about 0.07 wt. %, up to about 0.08 wt. %, up to about 0.09 wt. %, up to about 0.1 wt. %, up to about 0.1034 wt. %, up to about 0.11 wt. %, up to about 0.12 wt. %, or up to about 0.15 wt. %. In other embodiments, cypermethrin may be included in a range between about 0.01 wt. % and about 5 wt. %, or between about 0.01 wt. % and about 3 wt. %, or between about 0.01 wt. % and about 2 wt. %, or between about 0.01 wt. % and about 1 wt. %, or between about 0.01 wt. % and about 0.5 wt. %, or between about 0.01 wt. % and about 0.3 wt. %, or between about 0.01 wt. % and about 0.2 wt. %, or between about 0.01 wt. % and about 0.15 wt. %. Further, in particular embodiments, the cypermethrin may be included in a concentration of about 0.1 wt. %.

Imiprothrin (CAS No. 72963-72-5) is a synthetic pyrethroid that behaves as a fast-acting neurotoxin in insects. Imiprothrin has the IUPAC name [2,5-Dioxo-3-(prop-2-yn-1-yl) imidazolidin-1-yl]methyl 2,2-dimethyl-3-(2-methylprop-1-en-1-yl) cyclopropane-1-carboxylate. Imiprothrin can be included in the composition in at least 0.005 wt. % or at least 0.01 wt. % and up to about 0.02 wt. %, up to about 0.03 wt. %, up to about 0.04 wt. %, up to about 0.05 wt. %, up to about 0.06 wt. %, up to about 0.07 wt. %, up to about 0.08 wt. %, up to about 0.09 wt. %, up to about 0.1 wt. %, up to about 0.11 wt. %, up to about 0.1188 wt. %, up to about 0.12 wt. %, or up to about 0.15 wt. %. In other embodiments, imiprothrin may be included in a range between about 0.01 wt. % and about 5 wt. %, or between about 0.01 wt. % and about 3 wt. %, or between about 0.01 wt. % and about 2 wt. %, or between about 0.01 wt. % and about 1 wt. %, or between about 0.01 wt. % and about 0.5 wt. %, or between about 0.01 wt. % and about 0.3 wt. %, or between about 0.01 wt. % and about 0.2 wt. %, or between about 0.01 wt. % and about 0.15 wt. %. Further, in particular embodiments, the imiprothrin may be included in a concentration of about 0.12 wt. %.

Deltamethrin (CAS No. 52918-63-5) is a synthetic pyrethroid that behaves as a fast-acting neurotoxin in insects. Deltamethrin has the IUPAC name [(S)-cyano-(3-phenoxyphenyl)methyl](1R,3R)-3-(2,2-dibromoethenyl)-2,2-dimethylcyclopropane-1-carboxylate. Deltamethrin can be included in the composition in at least 0.01 wt. % or at least 0.05 wt. % or at least 0.1 wt. % and up to about 0.15 wt. %, up to about 0.2 wt. %, up to about 0.25 wt. %, up to about 0.3 wt. %, up to about 0.35 wt. %, up to about 0.4 wt. %, up to about 0.45 wt. %, or up to about 0.5 wt. %. In other embodiments, deltamethrin may be included in a range between about 0.01 wt. % and about 5 wt. %, or between about 0.01 wt. % and about 3 wt. %, or between about 0.01 wt. % and about 2 wt. %, or between about 0.01 wt. % and about 1 wt. %, or between about 0.01 wt. % and about 0.5 wt. %, or between about 0.01 wt. % and about 0.3 wt. %, or between about 0.01 wt. % and about 0.2 wt. %, or between about 0.01 wt. % and about 0.15 wt. %. Further, in particular embodiments, deltamethrin may be included in a concentration of about 0.3 wt. %.

Solvent. The composition of the present disclosure may also include a solvent, for example to dissolve certain components, to enhance functionality of the components, or for textural and sensorial attributes. In some embodiments, the solvent includes at least one of citric acid esters, cyclohexanone, glycol ethers, C14-C16 saturated alkanes, C11-C16 aliphatic hydrocarbons, and combinations thereof. In further embodiments, the solvent may additionally or alternatively include ethanol and acetone. The concentration of these non-VOC solvents is important for product performance because they dictate the rate at which the emulsion breaks. If the emulsion breaks too quickly, the composition dispenses as a continuous stream, rather than an aerosolized spray.

In certain embodiments, the composition includes a solvent. In these embodiments, the solvent may include at least one of citric acid esters, cyclohexanone, glycol ethers, C14-C16 saturated alkanes, C11-C16 aliphatic hydrocarbons, and combinations thereof. These C11-C16 aliphatic hydrocarbons may have no lingering chemical odors. In particular embodiments, the composition includes a hydrocarbon solvent and a non-VOC solvent. In these embodiments, the non-VOC solvent may be a citric acid ester, a glycol ether, or a combination thereof. Further, in these embodiments, the non-VOC solvents may assist with solubilizing the active agents, including cypermethrin, which has limited solubility in many solvents. Even further, the non-VOC solvent may solubilize with alkanes, C14-C16 linear hydrocarbon solvents, or other hydrocarbon solvents.

The concentration of the non-VOC solvent may also be critical to the functioning of the composition and may determine many parameters of the composition, such as how fast the emulsion breaks. For example, if the emulsion breaks too fast, the spray from the can may come out as a continuous stream and not an aerosolized spray, which is undesirable. Further, sometimes small variations in solvent amount may cause an emulsion to break too quickly and/or not form in the can when shaken. As such, one skilled in the art would understand the complexities with creating compositions with such solvents and the difficulty in creating optimal aerosol compositions having non-VOC solvents.

In some embodiments, the composition includes about 1 wt. % to about 55 wt. % of the solvent, and in some other embodiments, the composition includes about 1 wt. % to about 35 wt. % of the solvent, based on the total weight of the composition. In further embodiments, the composition includes about 25 wt. % to about 52 wt. % of the solvent based on the total weight of the composition. In further embodiments, the composition includes about 20 wt. % to about 35 wt. % of the solvent based on the total weight of the composition. In other embodiments, the composition includes a solvent present in about 28 wt. % to about 34 wt. %, based on the total weight of the composition, or between about 29 wt. % to about 34 wt. %, based on the total weight of the composition. In another embodiment, the solvent is present between about 28 wt. % to about 29 wt. %, based on the total weight of the composition. In another embodiment, the solvent is present between about 29 wt. % to about 30 wt. %, based on the total weight of the composition. In another embodiment, the solvent is present between about 30 wt. % to about 31 wt. %, based on the total weight of the composition. In yet another embodiment, the solvent is present between about 32 wt. % to about 33 wt. %, based on the total weight of the composition. In yet another embodiment, the solvent is present between about 33 wt. % to about 34 wt. %, based on the total weight of the composition. In other embodiments, the one or more solvents may be individually present in an amount ranging from about 0.01 wt. % and about 10 wt. %, or between about 0.01 wt. % and about 7 wt. %, or between about 0.01 wt. % and about 5 wt. %, or between about 0.01 wt. % and about 4.5 wt. %, or between about 0.01 wt. % and about 3 wt. %, or between about 0.01 wt. % and about 2.5 wt. %. While specific values chosen for this embodiment are recited, it is to be understood that, within the scope of the disclosure, the concentration of solvent may vary to suit different applications. The concentration ranges of solvents will vary based on the additional components of the pest control composition, including, but not limited to, the cypermethrin, deltamethrin, imiprothrin, emulsifier, propellant, corrosion inhibitor, and carrier.

Additionally, according to one embodiment, the solvent includes at least one of citric acid esters, cyclohexanone, glycol ethers, C14-C16 saturated alkanes, C11-C16 aliphatic hydrocarbons, and/or combinations thereof. For example, in an embodiment, the solvent includes at least one of C14-C16 saturated alkanes, glycol ethers, and/or combinations thereof. In another embodiment, the solvent includes at least one of C14-C16 saturated alkanes, citric acid esters, and/or combinations thereof. In an even further embodiment, the solvent is selected from the group consisting of citric acid esters, cyclohexanone, glycol ethers, C14-C16 saturated alkanes, C11-C16 aliphatic hydrocarbons, and/or combinations thereof.

Further, according to one embodiment, the solvent includes C11-C16 aliphatic hydrocarbons. Here, the solvent may be an isoparaffin or isoparaffinic hydrocarbon, including synthesized mixtures of hydrocarbons. For example, some exemplary embodiments may include one or more of the following solvents: Ketrul® D100 (TotalEnergies SE, La Défense 6, France), Isopar® M (Exxon Mobil Corporation, Irving, TX), Isopar™ L (Exxon Mobil Corporation, Irving, TX), SMD 100 by Sinopec, SMD 95 by Sinopic, ShellSol TD, and combinations thereof. In these embodiments, the composition includes about 25 wt. % to about 44 wt. % of C11-C16 aliphatic hydrocarbons, based on the total weight of the composition. In further embodiments, the composition includes about 28 wt. % to about 35 wt. % of C11-C16 aliphatic hydrocarbons, based on the total weight of the composition, or about 28.20 wt. % to about 34.50 wt. %. In even further embodiments, the composition includes about 30.7 wt. % to about 30.8 wt. % of C11-C16 aliphatic hydrocarbons, based on the total weight of the composition. In other embodiments, however, the composition is substantially free of C11-C16 aliphatic hydrocarbons. While specific values chosen for this embodiment are recited, it is to be understood that, within the scope of the disclosure, the concentration of C11-C16 aliphatic hydrocarbons may vary to suit different applications. The concentration ranges of C11-C16 aliphatic hydrocarbons, for example, will vary based on the additional components of the pest control composition, such as the active agents, the propellant, and the carrier.

In another embodiment, the solvent includes C14-C16 saturated alkanes. Here, the solvent may include a solvent of alkane mixtures. For example, some exemplary embodiments may include one or more of the following solvents: Ketrul® D100 (TotalEnergies SE, La Défense 6, France); gas-to-liquid (GTL) solvents, such as GS1927; Linpar® 1416 (Sasol Italy S.P.A., Milano, Italy), Ketrul® D80 (TotalEnergies SE, La Défense 6, France), SMD 80 by Sinopec, and/or Exxsol™ D80 (Exxon Mobil Corporation, Irving, TX). In these embodiments, the composition includes about 25 wt. % to about 44 wt. % of C14-C16 saturated alkanes, based on the total weight of the composition. In further embodiments, the composition includes about 28 wt. % to about 35 wt. % of C14-C16 saturated alkanes, based on the total weight of the composition. In even further embodiments, the composition includes about 28.2 wt. % to about 34.5 wt. % of C14-C16 saturated alkanes, based on the total weight of the composition. In still further embodiments, the composition includes about 32.64 wt. % of C14-C16 saturated alkanes, based on the total weight of the composition. In other embodiments, however, the composition is substantially free of C14-C16 saturated alkanes. While specific values chosen for this embodiment are recited, it is to be understood that, within the scope of the disclosure, the concentration of C14-C16 saturated alkanes may vary to suit different applications. The concentration ranges of C14-C16 saturated alkanes, for example, will vary based on the additional components of the pest control composition, such as the active agents, the propellant, and the carrier.

In yet another embodiment, the solvent includes glycol ethers. For example, some exemplary embodiments may include one or more of the following solvents: Butyl CARBITOL™ Solvent (Dow Chemical Co., Midland, MI), DOWANOL® DPnP Glycol Ether (Dow Chemical Co., Midland, MI), Hexyl CARBITOL™ Solvent (Dow Chemical Co., Midland, MI), Hexyl CELLOSOLVE™ (Dow Chemical Co., Midland, MI), DOWANOL® PPh Glycol Ether (Dow Chemical Co., Midland, MI), and/or glycol ether solvents offered by LyondellBasell® (LyondellBasell Industries Holdings BV (besloten vennootschap (b.v.); NETHERLANDS)), including glycol ether DB and glycol ether DE, for example. In these embodiments, the composition includes about 0.1 wt. % to about 10 wt. % of glycol ethers, based on the total weight of the composition. In further embodiments, the composition includes about 0.15 wt. % to about 5 wt. % of glycol ethers, based on the total weight of the composition. In even further embodiments, the composition includes about 0.2 wt. % to about 2.5 wt. % of glycol ethers, based on the total weight of the composition. In other embodiments, the composition includes about 0.2 wt. % to about 1.5 wt. %, or about 0.2 wt. % to about 1.3 wt. % of glycol ethers, based on the total weight of the composition. In some embodiments, however, the composition is substantially free of glycol ethers. While specific values chosen for this embodiment are recited, it is to be understood that, within the scope of the disclosure, the concentration of glycol ethers may vary to suit different applications. The concentration ranges of glycol ethers, for example, will vary based on the additional components of the pest control composition, such as the active agents, the propellant, and the carrier.

Still further, in some embodiments, the solvent includes citric acid esters. For example, some exemplary embodiments may include one or more of the following solvents: a triethyl citrate (e.g., Citroflex® C-2 Aurorium Holdings LLC, Indianapolis, IN), acetyltriethyl citrate (e.g., Citroflex® A-2), tri-n-butyl citrate (e.g., Citroflex® C-4), acetyltri-n-butyl citrate (Citroflex® A-4), acetyltri-n-hexyl citrate (Citroflex® A-6), n-Butyryltri-n-hexyl citrate (Citroflex® B-6), and combinations thereof. Citroflex® solvents are biodegradable and non-toxic, and Citroflex® A-4, also called acetyl-tri-n-butyl citrate, is phthalate-free. In these embodiments, the composition includes about 0.1 wt. % to about 10 wt. % of citric acid esters, based on the total weight of the composition. In further embodiments, the composition includes about 0.15 wt. % to about 8 wt. % of citric acid esters, based on the total weight of the composition. In even further embodiments, the composition includes about 0.2 wt. % to about 2.5 wt. % of citric acid esters, based on the total weight of the composition. In other embodiments, the composition includes about 0.2 wt. % to about 1.3 wt. % of citric acid esters, based on the total weight of the composition. In other embodiments, however, the composition is substantially free of citric acid esters. While specific values chosen for this embodiment are recited, it is to be understood that, within the scope of the disclosure, the concentration of citric acid esters may vary to suit different applications. The concentration ranges of glycol ethers, for example, will vary based on the additional components of the pest control composition, such as the active agents, the propellant, and the carrier.

Emulsifier. The composition of the present disclosure may also include an emulsifier, for example, to keep the active ingredient emulsified in the composition. The concentration of emulsifier is also important for product performance. A composition having too low a concentration of emulsifier exhibits inferior spray due to incomplete emulsion formation, while a composition having too high a concentration of emulsifier exhibits a thick, foamy spray which impacts insecticide performance. In some embodiments, the composition includes an emulsifier. In some embodiments, the emulsifier includes at least one of lecithin, sodium lauryl sulfate, sodium oleate, potassium oleate, sodium ricinolate, Quillaja saponin, polyglyceryl oleate, glyceryl monooleate, sorbitan monooleate, and any combinations thereof.

In certain embodiments, the emulsifier is present in about 0.01 wt. % to about 5 wt. %, based on the total weight of the composition. In an embodiment, the emulsifier is present from about 0.01 wt. % to about 4 wt. %, based on the total weight of the composition. In other embodiments, the composition includes about 0.01 wt. % to about 3 wt. % emulsifier, based on the total weight of the composition. In some embodiments, the composition includes about 0.01 wt. % to about 2 wt. % emulsifier, based on the total weight of the composition. In certain embodiments, the composition includes about 0.01 wt. % to about 1 wt. % emulsifier, based on the total weight of the composition. In an embodiment, the emulsifier is present from about 0.01 wt. % to about 0.5 wt. %, based on the total weight of the composition. In an embodiment, the emulsifier is present from about 0.05 wt. % to about 0.2 wt. %, based on the total weight of the composition. In even further embodiments, however, the composition is substantially free of an emulsifier. While specific values chosen for this embodiment are recited, it is to be understood that, within the scope of the disclosure, the concentration of emulsifier may vary to suit different applications and product formulations (e.g., foaming aerosol vs. fast breaking emulsion aerosol). The concentration ranges of emulsifier will vary based on the additional components of the pest control composition, including, but not limited to, the solvent, the carrier, corrosion inhibitor, propellant, and the active agents.

Further, according to one embodiment, the emulsifier includes sorbitan monooleate. In this embodiment, the sorbitan monooleate is present from about 0.01 wt. % to about 4 wt. %, based on the total weight of the composition. In other embodiments, the composition includes about 0.01 wt. % to about 3 wt. % sorbitan monooleate, based on the total weight of the composition. In some embodiments, the composition includes about 0.01 wt. % to about 2 wt. % sorbitan monooleate, based on the total weight of the composition. In certain embodiments, the composition includes about 0.01 wt. % to about 1 wt. % sorbitan monooleate, based on the total weight of the composition. In an embodiment, the sorbitan monooleate is present from about 0.05 wt. % to about 0.2 wt. %, based on the total weight of the composition. In further embodiments, the sorbitan monooleate is present at about 0.115 wt. %, based on the total weight of the composition. In even further embodiments, however, the composition is substantially free of sorbitan monooleate. While specific values chosen for this embodiment are recited, it is to be understood that, within the scope of the disclosure, the concentration of sorbitan monooleate may vary to suit different applications. The concentration ranges of sorbitan monooleate will vary based on the additional components of the pest control composition, including, but not limited to, the solvent, the carrier, corrosion inhibitor, propellant, and the active agents.

Carrier. The composition of the present disclosure may also include a carrier, for example, to help aid in the delivery of the active agents, diluent, and flow aid. The carrier may improve content uniformity and facilitates reproducibility of the applied dose. The carrier, among other ingredients, allows the pesticide to be dispersed effectively. The term “carrier” as used herein means a material, which can be inorganic or organic and of synthetic or natural origin, with which the active agent is mixed or formulated to facilitate its application to the host, area, or other object to be treated, or to facilitate its storage, transport, and/or handling. In general, any of the materials customarily employed in formulating repellents, pesticides, herbicides, or fungicides, are suitable.

In certain embodiments, the composition includes about 5 wt. % to about 95 wt. % of a carrier, or about 5 wt. % and about 90 wt. %, or about 5 wt. % to about 85 wt. %, or about 5 wt. % to about 80 wt. %, or between about 5 wt. % to about 75 wt. %, or between 5 wt. % to about 70 wt. %, or about 5 wt. % to about 65 wt. %. In further embodiments, the formulation includes about 50 wt. % to about 70 wt. % carrier, based on the total weight of the composition. In certain embodiments, the composition includes about 55.5 wt. % to about 62.5 wt. % carrier, based on the total weight of the composition. In other embodiments, the composition includes about 55 wt. % to about 63 wt. % carrier, based on the total weight of the composition. In still further embodiments, the composition includes about 57 wt. % to about 60 wt. % carrier, based on the total weight of the composition. In still further embodiments, the composition includes about 58 wt. % carrier or about 59 wt. % carrier, based on the total weight of the composition. In some embodiments, the carrier includes purified water. In other embodiments, the carrier is purified water. In further embodiments, the carrier is an oil, such as mineral oil. While specific values chosen for this embodiment are recited, it is to be understood that, within the scope of the disclosure, the amount of carrier may vary to suit different applications. The amount ranges of carrier will vary based on the additional components of the pest control composition, such as the active agents, solvent, corrosion inhibitor, and emulsifier.

Corrosion Inhibitor. The composition of the present disclosure may also include a corrosion inhibitor, for example, to help prevent degradation of a metal container that is used to store and/or dispense the composition. The pest control formulation as disclosed herein can be provided to the user in a metal container. Preventing the corrosion of the container is important to avoid spilling and wasting the contents if the container is stored for an extended period of time between uses. Therefore, a corrosion inhibitor can be added to the formulation to increase shelf life. Corrosion inhibitors can include inorganic compounds as well as aliphatic or aromatic amines, and nitrogen heterocyclic compounds. In specific embodiments herein, the organic salt ammonium benzoate is used as a corrosion inhibitor. In some embodiments, ammonium benzoate is included at about 0.05 wt. % to about 2 wt. %, or about 0.05 wt. % to about 1 wt. %, or about 0.05 wt. % to about 0.5 wt. %, or about 0.05 wt. % to about 0.2 wt. %, based on the total weight of the composition. In some embodiments, ammonium benzoate is included at about 0.075 wt. % to about 0.15 wt. %, based on the total weight of the composition. In a particular embodiment, ammonium benzoate can be included at about 0.08 wt. % to about 0.11 wt. %, based on the total weight of the composition. In a particular embodiment, ammonium benzoate can be included at about 0.090 wt. % or 0.105 wt. %, based on the total weight of the composition. In even further embodiments, however, the composition is substantially free of a corrosion inhibitor. While specific values chosen for this embodiment are recited, it is to be understood that, within the scope of the disclosure, the concentration of corrosion inhibitor may vary to suit different applications. The concentration ranges of corrosion inhibitor will vary based on the additional components of the pest control composition, including, but not limited to, the solvent, the carrier, emulsifier, propellant, and the active agents.

Propellant. In certain embodiments, the composition includes a propellant, for example, to provide a force to expel the formulation from the container. In certain embodiments, the propellant is selected from the group comprising methane, ethane, propane, pentane, isobutene, n-butane, isobutane, dimethyl ether, carbon dioxide, nitrogen, air, liquified petroleum gas, and any combinations thereof. In certain embodiments, the propellant is selected from the group consisting of methane, ethane, propane, pentane, isobutene, n-butane, isobutane, dimethyl ether, carbon dioxide, nitrogen, air, and any combinations thereof. In some embodiments, the propellant can be pressurized in the can to about 50 psi, about 60 psi, about 70 psi, about 80 psi, about 90 psi, or about 100 psi. In other embodiments, the propellant pressure is between about 70 psi and about 100 psi, or between about 80 psi and about 96 psi. In certain embodiments, the composition includes about 1 wt. % to about 10 wt. % of the propellant, based on the total weight of the composition. In certain embodiments, the composition includes about 5 wt. % to about 8 wt. % of the propellant, based on the total weight of the composition. In certain embodiments, the composition includes about 6.5 wt. % to about 8 wt. % of the propellant, based on the total weight of the composition. In certain embodiments, the composition includes about 7 wt. % to about 8 wt. % of the propellant, based on the total weight of the composition. In certain embodiments, the composition includes about 7.5 wt. % of the propellant, based on the total weight of the composition. In specific embodiments, the composition includes a propellant at a weight percentage below 10 wt. %, below 9 wt. %, or below 8 wt. %.

Further, in some embodiments, the propellant is at least partially a part of the composition and dissolves in the active or organic phase of the formulation. As a result, the propellant helps with the formation of the emulsion system. While specific values chosen for this embodiment are recited, it is to be understood that, within the scope of the disclosure, the concentration of propellant may vary to suit different applications. The concentration ranges of propellant will vary based on the additional components of the pest control composition, including, but not limited to, the solvent, the carrier, surfactant, corrosion inhibitor, and the active agents.

In certain embodiments, the propellant includes at least one of isobutane, propane, or combinations thereof. In certain embodiments, the propellant includes a combination of isobutane and propane with an isobutane to propane weight ratio of about 20:80 to about 45:55. In a further embodiment, the propellant includes a combination of isobutane and propane with an isobutane to propane weight ratio of about 30:70. In a further embodiment, the propellant is an A-90 propellant, including a combination of isobutane and propane with an isobutane to propane weight ratio of about 30.16:69.84. In a further embodiment, the propellant is an A-70 propellant, including a combination of isobutane and propane with an isobutane to propane weight ratio of about 57.11:42.89. If the weight ratio of isobutane to propane exceeds 21.27:78.73, it was found that the propellant pressure produces a fine mist, with particle sizes which are ill-suited to targeting crawling insects. When particle sizes are too small, they form fine droplets which allow the active agents or carrier agents to quickly evaporate, which then hinders the delivery of actives through the insect's cuticles. By balancing the isobutane to propane ratio, a stable emulsion which produces the proper energy when leaving the actuator was produced. In particular, a correct balance of the isobutane to propane ratio helped to solubilize with the composition and create an emulsion, while still having enough propane to give the energy needed for flash vaporization in the nozzle. This contrasts with other mainstream aerosols that have much higher propellant pressure, producing fine particles and a wide spray diameter. Once in the air, the propellent in the formula helps break up the formulation into the correct diameter of particles, allowing the composition to hit and coat the target insect. This demonstrates the importance of having the correct propellant ratio in the formula. By optimizing the propellant composition, a formulation which allows for flexibility and interchangeability between actuators and valves was produced.

Fragrance. In certain embodiments, the composition includes a fragrance, for example, to improve the scent of the composition. A fragrance suitable for use as an active agent may be any suitable natural or synthetic fragrance, based on a single component or blend of components. Fragrances are available commercially from fragrance manufacturers such as Takasago, International Flavors & Fragrances Inc., Quest, Firmenich, Givaudan, Symrise and the like.

In certain embodiments, the fragrance is present in about 0.01 wt. % to about 1 wt. %, based on the total weight of the composition. In an embodiment, the fragrance is present from about 0.01 wt. % to about 0.5 wt. %, based on the total weight of the composition. In other embodiments, the composition includes about 0.1 wt. % to about 0.3 wt. % fragrance, based on the total weight of the composition. In some embodiments, the composition includes about 0.2 wt. % to about 0.25 wt. % fragrance, based on the total weight of the composition. In even further embodiments, however, the composition is substantially free of a fragrance.

Further, the propellant and the concentration thereof may assist with creating optimal spray characteristics for the composition. In particular, in some embodiments, the composition may have a discharge rate between about 1 g/s and about 6.0 g/s, or between about 1.5 g/s and about 4.0 g/s, or between about 2.0 g/s and about 3.5 g/s, or between about 2.2 g/s and about 3.4 g/s, or between about 2.5 g/s and about 3.5 g/s, or between about 2.6 g/s and about 3.2 g/s. In particular embodiments, the composition may have a discharge rate of about 2.9 g/s.

The composition may also have an optimal particle size, such as an optimal Dv(50) value. In some embodiments, the composition may have a Dv(50) value between about 100 μm and about 300 μm, or between about 100 μm and about 250 μm, or between about 130 μm and about 210 μm, or between about 150 μm and about 200 μm, or between about 165 μm and about 195 μm. In particular embodiments, the composition includes a Dv(50) particle size of about 180 μm.

The composition may also have an optimal pattern diameter. In these embodiments, the pattern diameter may be between about 1 inch and about 8 inches, or between about 3 inches and about 5 inches, or between about 3.5 inches and about 4 inches.

The composition may also have an optimal spray distance. In these embodiments, the spray distance may be between about 6 inches and about 30 inches, or between about 15 inches and about 20 inches. In particular embodiments, the spray distance may be about 18 inches.

### EXAMPLES

The following Examples are provided to demonstrate and further illustrate certain embodiments and aspects of the present disclosure and are not to be construed as limiting the scope of the disclosure.

### Example 1. Creation of Stable, Low-VOC Insecticide Formulations

According to embodiments of the disclosure, the composition can include an active agent or combination of active agents, a solvent or combination of solvents, an emulsifier, a carrier, a propellant, and a corrosion inhibitor. Five exemplary formulations (i.e., Formulation 1, Formulation 2, Formulation 3, Formulation 4, and Formulation 5) are shown in Table 1, all of which produced stable compositions having a VOC content of less than 10 wt. % (i.e., a VOC content of about 7.2 wt. % to about 7.85 wt. %). All concentrations are in wt. %, based on the total weight of the composition. A fragrance wt. % value of 0% indicates that the composition is substantially free of fragrance.

TABLE 1
Exemplary formulations.

| Ingredient | Formulation 1 | Formulation 2 | Formulation 3 | Formulation 4 | Formulation 5 |
|---|---|---|---|---|---|
| Linpar ® 1416 | — | 25.0-44.0 | 25.0-44.0 | 25.0-44.0 | 25.0-44.0 |
| (Solvent) | | | | | |
| Isopar ® M (Solvent) | 25.0-44.0 | — | — | — | — |
| DOWANOL ® DPnP | — | — | 0.2-1.5 | — | 0.15-5.0 |
| Glycol Ether (Solvent) | | | | | |
| Citroflex ® A-4 | — | — | — | 0.15-8.0 | — |
| (Solvent) | | | | | |
| Sorbitan Monooleate | 0.05-2.0 | 0.05-2.0 | 0.05-2.0 | 0.05-2.0 | 0.05-2.0 |
| (Emulsifier) | | | | | |
| Imiprothrin (Active) | 0.12 | 0.12 | 0.12 | 0.12 | 0.12 |
| Cypermethrin 96.7% | — | — | — | 0.10 | 0.10 |
| (Active) | | | | | |
| Ultratec 10% MUP / | 0.30 | 0.30 | 0.30 | — | — |
| Deltamethrin (Active) | | | | | |
| Fragrance | — | — | 0.00-0.25 | 0.00-0.25 | 0.00-0.25 |
| Purified Water | 50.0-70.0 | 50.0-70.0 | 50.0-70.0 | 50.0-70.0 | 50.0-70.0 |
| (Carrier) | | | | | |
| Ammonium Benzoate | 0.05-0.50 | 0.05-0.50 | 0.05-0.50 | 0.05-0.50 | 0.05-0.50 |
| (Corrosion Inhibitor) | | | | | |
| A-90 Propellant | 6.5-8.0 | 6.5-8.0 | 6.5-8.0 | 6.5-8.0 | 6.5-8.0 |

Additionally, all of the formulations had a propellant with isobutane in a weight percentage between about 27.27 wt. % and about 44.13 wt. %, based on a weight of the propellant, and propane in a weight percentage between about 55.87 wt. % and about 78.73 wt. %, based on the weight of the propellant.

### Example 2. Spray Performance of Stable, Low-VOC Insecticide Formulations

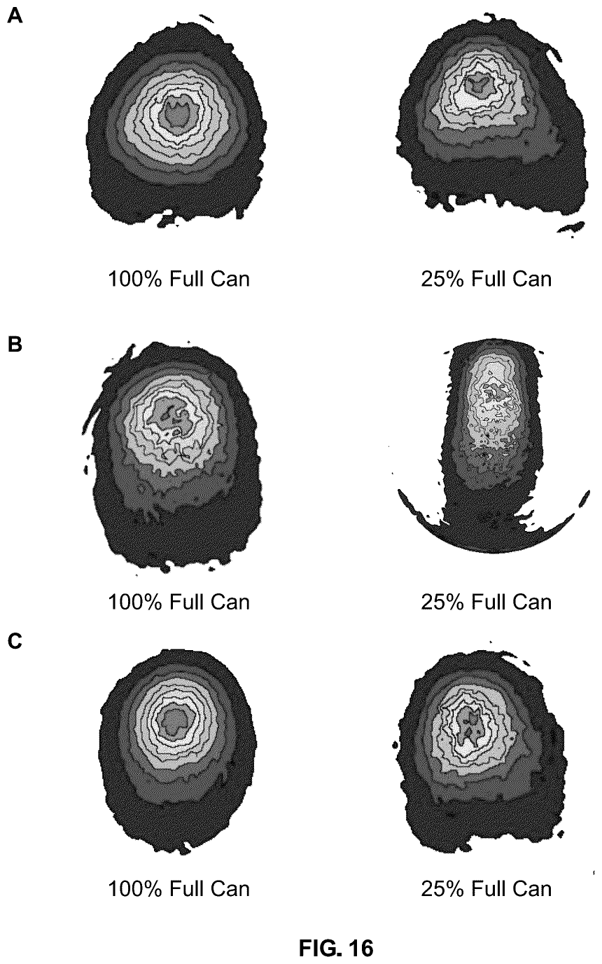

The spray performance of the present disclosure was compared against a reference formula using the overcap assemblies disclosed herein. In particular, with reference to FIG. 16, two formulations of the present disclosure (i.e., Formulations A and B) were compared with a reference formulation (i.e., Formulation C). Further information on Formulations A-C is shown in Tables 2 and 3, below.

TABLE 2
Discharge rate and particle size of
Formulations A-C at 100% full can

| Formulation | Discharge Rate | Particle Size |
|---|---|---|
| Formulation A | 2.73 ± 0.3 | 178.1 ± 10 |
| Formulation B | 3.14 ± 0.3 | 199.0 ± 10 |
| Formulation C | 2.90 ± 0.3 | 181.9 ± 10 |

TABLE 3
Discharge rate and particle size of
Formulations A-C at 25% full can

| Formulation | Discharge Rate | Particle Size |
|---|---|---|
| Formulation A | 2.58 ± 0.3 | 176.8 ± 10 |
| Formulation B | 3.00 ± 0.3 | 205.4 ± 10 |
| Formulation C | 2.71 ± 0.3 | 196.5 ± 10 |

Further, additional information on the ingredients of Formulations A-C of the present disclosure are shown in Table 4 below.

TABLE 4
Ingredients of Formulations B and C.

| Ingredient | Formulation A | Formulation B | Formulation C |
|---|---|---|---|
| Linpar 1416 (Solvent) | 27.50-27.70 | 25.0-44.0 | 25.0-44.0 |
| Isopropyl Alcohol | 2.00 | — | — |
| DOWANOL ® DPnP | — | — | — |
| Glycol Ether (Solvent) | | | |
| Citroflex ® | — | 0.15-8.0 | 0.15-8.0 |
| A-4 (Solvent) | | | |
| Sorbitan Monooleate | 0.0699 | 0.05-2.0 | 0.05-2.0 |
| (Emulsifier) | | | |
| Imiprothrin (Active) | 0.1188 | 0.12 | 0.12 |
| Cypermethrin 96.7% | 0.1034 | 0.10 | 0.10 |
| (Active) | | | |
| Ultratec 10% MUP / | — | — | — |
| Deltamethrin (Active) | | | |
| Fragrance | 0.00-0.25 | 0.00-0.25 | 0.00-0.25 |
| Purified Water | 59.8998 | 50.0-70.0 | 50.0-70.0 |
| (Carrier) | | | |
| Ammonium Benzoate | 0.1002 | 0.05-0.50 | 0.05-0.50 |
| (Corrosion Inhibitor) | | | |
| A-90 Propellant | — | 6.5-8.0 | 6.5-8.0 |
| A-70 Propellant | 10.00 | — | — |

Formulation A had a propellant with an isobutane to propane weight ratio of about 57.11:42.89. Formulations B and C had a propellant with an isobutane to propane weight ratio of about 30.16:69.84.

The overcap assembly 100 was used to dispense Formulation A and the diameter D1 of the exit aperture or orifice 108 was about 1.00 mm. Next, the overcap assembly 200 was used to dispense Formulation B, and in this embodiment, the diameter D2 of the exit aperture or orifice 208 was about 1.30 mm. Last, the overcap assembly 200 was also used to dispense Formulation C, and in this embodiment, the diameter D2 of the exit aperture or orifice 208 was about 1.00 mm.

FIG. 16 illustrates the several spray patterns of the overcap assemblies and formulations of the present disclosure. With reference to FIG. 16, the spray pattern and performance of the formulations of the present disclosure (i.e., Formulations B and C) were comparable or consist with reference formulation (i.e., Formulation A). In particular, Formulation C, in combination with the overcap assembly 200 and an exit orifice 208 having a diameter D2 of about 1.00 mm, created spray patterns that were comparable with the reference Formulation A. Therefore, despite the reduction in propellant and decreased levels of VOC, the formulations and dispensing systems of the present disclosure were still able to achieve optimal spray patterns.

The various methods and techniques described above provide a number of ways to carry out embodiments of the present disclosure. Of course, it is to be understood that not necessarily all objectives or advantages described may be achieved in accordance with any particular embodiment described herein. Thus, for example, those skilled in the art will recognize that the methods can be performed in a manner that achieves or optimizes one advantage or group of advantages as taught herein without necessarily achieving other objectives or advantages as may be taught or suggested herein. A variety of advantageous and disadvantageous alternatives are mentioned herein. It is to be understood that some preferred embodiments specifically include one, another, or several advantageous features, while others specifically exclude one, another, or several disadvantageous features, while still others specifically mitigate a present disadvantageous feature by inclusion of one, another, or several advantageous features.

Furthermore, the skilled artisan will recognize the applicability of various features from different embodiments. Similarly, the various elements, features and steps discussed above, as well as other known equivalents for each such element, feature or step, can be mixed and matched by one of ordinary skill in this art to perform methods in accordance with principles described herein. Among the various elements, features, and steps some will be specifically included and others specifically excluded in diverse embodiments.

Although the invention has been disclosed in the context of certain embodiments and examples, it will be understood by those skilled in the art that the embodiments of the invention extend beyond the specifically disclosed embodiments to other alternative embodiments and/or uses and modifications and equivalents thereof.

Many variations and alternative elements have been disclosed in embodiments of the present invention. Still further variations and alternate elements will be apparent to one of skill in the art. Among these variations, without limitation, are the at least two active ingredients selected for the pest control composition, the target pest, and the amounts of the various ingredients present in the pest control composition. Various embodiments of the invention can specifically include or exclude any of these variations or elements.

In some embodiments, the numbers expressing quantities of ingredients, properties such as weight percentages, percent repellency, and so forth, used to describe and claim certain embodiments of the invention are to be understood as being modified in some instances by the term “about.” Accordingly, in some embodiments, the numerical parameters set forth in the written description and attached claims are approximations that can vary depending upon the desired properties sought to be obtained by a particular embodiment. In some embodiments, the numerical parameters should be construed in light of the number of reported significant digits and by applying ordinary rounding techniques. Notwithstanding that the numerical ranges and parameters setting forth the broad scope of some embodiments of the invention are approximations, the numerical values set forth in the specific examples are reported as precisely as practicable. The numerical values presented in some embodiments of the invention may contain certain errors necessarily resulting from the standard deviation found in their respective testing measurements.

In some embodiments, the terms “a” and “an” and “the” and similar references used in the context of describing a particular embodiment of the present disclosure (especially in the context of certain of the following claims) can be construed to cover both the singular and the plural. The recitation of ranges of values herein is merely intended to serve as a shorthand method of referring individually to each separate value falling within the range. Unless otherwise indicated herein, each individual value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided with respect to certain embodiments herein is intended merely to better illuminate the invention and does not pose a limitation on the scope of the invention otherwise claimed. No language in the specification should be construed as indicating any non-claimed element essential to the practice of the invention.

Groupings of alternative elements or embodiments of the invention disclosed herein are not to be construed as limitations. Each group member can be referred to and claimed individually or in any combination with other members of the group or other elements found herein. One or more members of a group can be included in, or deleted from, a group for reasons of convenience and/or patentability. When any such inclusion or deletion occurs, the specification is herein deemed to contain the group as modified thus fulfilling the written description of all Markush groups used in the appended claims.

Particular embodiments of the present disclosure are described herein. It is contemplated that skilled artisans can employ such variations as appropriate, and the invention can be practiced otherwise than specifically described herein. Accordingly, many embodiments of this invention include all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

It is to be understood that the embodiments of the invention disclosed herein are illustrative of the principles of the present invention. Other modifications that can be employed can be within the scope of the invention. Thus, by way of example, but not of limitation, alternative configurations of the present invention can be utilized in accordance with the teachings herein. Accordingly, embodiments of the present invention are not limited to that precisely as shown and described.

We claim:

1. A pesticidal composition, the composition comprising:
an active phase including one or more solvents and an active;
an aqueous phase including water; and
a propellant,
wherein the one or more solvents are selected from the group consisting of citric acid esters, cyclohexanone, ethanol, acetone, glycol ethers, C14-16 saturated alkanes, C11-C16 aliphatic hydrocarbons; and
wherein the composition has a volatile organic compound content of less than 8 wt. %, based on a total weight of the composition.

2. The pesticidal composition of claim 1, wherein the active is at least one of cypermethrin, imiprothrin, and combinations thereof, the one or more solvents include glycol ethers and C14-C16 saturated alkanes, and the propellant is less than about 8 wt. %, based on a total weight of the composition.

3. The pesticidal composition of claim 1, wherein the active is at least one of cypermethrin, imiprothrin, and combinations thereof, the one or more solvents include citric acid esters and C14-C16 saturated alkanes, and the propellant is less than about 8 wt. %, based on a total weight of the composition.

4. The pesticidal composition of claim 1, wherein the composition further includes a sorbitan monooleate emulsifier between about 0.01 wt. % and 2 wt. %, based on a total weight of the composition.

5. The pesticidal composition of claim 1, wherein the composition further includes an ammonium benzoate corrosion inhibitor between about 0.01 wt. % and 2 wt. %, based on a total weight of the composition.

6. The pesticidal composition of claim 1, wherein the one or more solvents are above 25 wt. %, based on a total weight of the composition.

7. The pesticidal composition of claim 6, wherein the one or more solvents are selected from the group consisting of citric acid esters, glycol ethers, C11-C16 aliphatic hydrocarbons, C14-C16 saturated alkanes, and combinations thereof.

8. The pesticidal composition of claim 1, wherein the propellant includes isobutane and propane, and the isobutane to propane weight ratio is between about 20:80 to about 45:55.

9. A pesticidal composition, the composition comprising:
an active phase including one or more solvents and an active;
an aqueous phase including water; and
a propellant,
wherein the one or more solvents are above 30 wt. %, based on a total weight of the composition, and
wherein the composition has a volatile organic compound content of less than 8 wt. %, based on the total weight of the composition.

10. The pesticidal composition of claim 9, wherein the active is at least one of cypermethrin, deltamethrin, and combinations thereof, the one or more solvents include C11-C16 aliphatic hydrocarbons, and the propellant is less than 8 wt. %, based on the total weight of the composition.

11. The pesticidal composition of claim 9, wherein the active is at least one of cypermethrin, deltamethrin, and combinations thereof, the one or more solvents include C14-C16 saturated alkanes, and the propellant is less than 8 wt. %, based on the total weight of the composition.

12. The pesticidal composition of claim 9, wherein the active is at least one of cypermethrin, deltamethrin, and combinations thereof, the one or more solvents includes glycol ethers and C14-C16 saturated alkanes, and the propellant is less than 8 wt. %, based on the total weight of the composition.

13. The pesticidal composition of claim 9, wherein the one or more solvents are selected from the group consisting of citric acid esters, cyclohexanone, and glycol ethers.

14. The pesticidal composition of claim 13, wherein the one or more solvents are selected from the group consisting of citric acid esters, glycol ethers, and combinations thereof.

15. The pesticidal composition of claim 9, wherein the propellant includes isobutane and propane, and the isobutane to propane weight ratio is between about 20:80 to about 45:55.

16. A dispensing system comprising:
a container, wherein a composition is disposed within the container; and
an overcap assembly attached to the container, the overcap assembly comprising:
a body;
an actuator; and
a nozzle having an exit orifice with a diameter of between about 0.75 mm and about 2 mm,
wherein the composition comprises:
an active phase including one or more solvents and an active;
an aqueous phase including water; and
a propellant,
wherein the one or more solvents are selected from the group consisting of citric acid esters, glycol ethers, C14-16 saturated alkanes, and C11-C16 aliphatic hydrocarbons, and
wherein the composition has a volatile organic compound content of less than 8 wt. %, based on a total weight of the composition.

17. The dispensing system of claim 16, wherein the exit orifice has a diameter of between about 1.0 mm and about 1.3 mm.

18. The dispensing system of claim 16, wherein the composition is dispensed at a Dv(50) particle size of between about 130 μm and about 210 μm when the container is 100% full.

19. The dispensing system of claim 16, wherein the composition is dispensed at a discharge rate of between about 2.2 g/s and about 3.4 g/s.

20. The dispensing system of claim 16, wherein the system produces a spray distance between about 15 inches and about 20 inches.
